(19) United States
(12) Patent Application Publication
(10) Pub. No.: US 2012/0110013 A1
(43) Pub. Date: May 3, 2012

(54) Flexibly Filterable Visual Overlay Of Individual Genome Sequence Data Onto Biological Relational Networks

(76) Inventors: Jorge Conde, Cambridge, MA (US); Nathaniel Pearson, Somerville, MA (US)

(21) Appl. No.: 13/283,711

(22) Filed: Oct. 28, 2011

Related U.S. Application Data
(60) Provisional application No. 61/407,625, filed on Oct. 28, 2010.

(51) Int. Cl. G06F 7/00; G06F 17/30

(52) U.S. Cl. 707/772; 707/791; 707/E17.014; 707/E17.045

(57) ABSTRACT

The present invention pertains to methods, apparatuses and systems for providing a visually simple and salient display of an individual's genomic data overlaid onto one or more relational networks of one or more biological objects, such as information about genes, regulatory regions, promoters or enhancers. The present invention utilizes individual genomic variant information that is annotated with variant information of one or more relational networks having information of biological objects. The display also provides a representation as to the type and nature of individual's variant associated with the relational network such as homozygous variants, heterozygous variants, previously reported genotype-phenotype association, situation within a splice-site region, category of change (e.g., frameshift, nonsense, missense, etc.), predicted effect on protein function (function-changing, tolerated, etc.), and novelty.

### RELATED APPLICATION

This application claims the benefit of U.S. Provisional Application No. 61/407,625, filed Oct. 28, 2010.

The entire teachings of the above application are incorporated herein by reference.

### BACKGROUND OF THE INVENTION

Important functional links between sequence variants found in one or more given genomes are often very hard to discern from text-based and/or tabular data alone. Methods for filtering genome sequence data in order to identify potentially interacting variants conventionally take the form of queriable text tables, and as such fail to fully exploit the human brain's geometric pattern recognition abilities.

Additionally, current tools for visualizing biological relational networks (e.g., protein-protein, disease-disease, and gene-disease interaction networks, or metabolic reaction pathways) do not integrate an individual's genome sequence data, and are thus only generically useful.

Accordingly, a need exists for tools that summarize biological relational networks in the context of an individual's genome sequence data. A further need exists for tools that display such information and convey the degree and nature of the variant (e.g., a suspect variant).

### SUMMARY OF THE INVENTION

The present invention relates to methods for providing a display of an individual's genomic data overlaid onto one or more relational networks of one or more biological objects, wherein individual genomic variant information is annotated with variant information of one or more relational networks having information of one or more biological objects. The method includes providing a display of one or more relational networks having information of one or more biological objects for one or more variants of the individual. The term “variants” is used herein to include all variant spellings (e.g., the polymeric units of DNA (A,C,G,T) or RNA (A,C,G,U)) of a given segment of a genome shared by members of a population of organisms. Examples include certain alleles, polymorphisms, Single Nucleotide Polymorphisms (SNPs), indels, Copy Number Variants (CNVs), and Sindbis Virus (SVs). The variant information of one or more relational networks having information of one or more biological objects includes information about genes, regulatory regions, promoters or enhancers of the variant, insulator, metabolite, protein, functional RNA molecule, disease, condition, symptoms, protein interactions or other phenotype. The display further includes a representation of the relationship between the relational networks and/or a representation of one or more characteristics of the variant associated with one or more relational networks. Examples of such characteristics include one or more heterozygous variants, one or more homozygous variants, a missense variant, a suspect variant, a novel variant, or a non-suspect variant. The characteristic of the variant can be represented by any indicia including by one or more colors, symbols, shapes, numbers, characters, or a combination thereof.

In a computer system, the present invention also relates to a method for providing a display of one or more individual genomic datasets overlaid onto one or more relational networks of one or more biological objects, wherein the steps of the method involve providing a database comprising individual genomic variant information from one or more individuals wherein the individual genomic variant information is annotated with variant information of one or more relational networks having information of one or more biological objects. The method also includes providing a display of one or more relational networks having information of one or more biological objects for one or more variants of the individual and a representation of one or more characteristics of the variant associated with one or more relational networks; wherein the biological objects includes information about genes, regulatory regions, promoters or enhancers of the variant, disease, condition, symptoms, protein interactions or other phenotype. In an aspect, the information of the biological objects for the relational networks has information reported in a journal article or found in a publically available database of medical information. The display can include one or more relational networks having information from more than one individual genome.

In yet another embodiment, the present invention includes methods for providing a display of an individual's genomic data overlaid onto one or more relational networks of one or more biological objects, wherein the steps of the method include providing a database having individual genomic variant information annotated with variant information of one or more relational networks having information of one or more biological objects. The steps also include providing a display of one or more relational networks in response to a user's search string, wherein the relational networks has information of one or more biological objects for one or more variants of the individual and a representation of one or more characteristics of the variant associated with one or more relational networks; wherein the biological objects includes information about genes, regulatory regions, promoters or enhancers of the variant, insulators, metabolites, proteins, functional RNA molecules, diseases, conditions, symptoms, protein interactions or other phenotypes. The method further includes providing a representation of the relationship between the relational networks; and providing information about the variant. Information about the variant provided can include e.g., positional information, the nucleic acid residue at the variant position, phenotypic information or a combination thereof.

The present invention also pertains to a computer apparatus or system for providing a display of an individual's genomic data overlaid onto one or more relational networks of one or more biological objects. The apparatus or system includes a source (e.g., a database) of individual genomic variant information that is annotated with variant information of one or more relational networks having information of one or more biological objects, a memory module for storing a user application and the database, a processor module to receive the annotated dataset and to process information from the annotated dataset, communication interface for transfer data between the components, and an input/output interface (e.g., an output device) for displaying of one or more relational networks having information of one or more biological objects for one or more variants of the individual in reference with the annotated dataset. The display, in an aspect, has variant information of one or more relational networks having information of one or more biological objects that includes information about genes, regulatory regions, promoters or enhancers of the variant, disease, condition, symptoms, protein interactions or other phenotype. The display can also include a representation of the relationship between the relational networks, a representation of one or more characteristics of the variant associated with one or more relational networks or both. The display of the present invention, in an embodiment, provides characteristics of the variant represented that includes one or more heterozygous variants, one or more homozygous variants, a missense variant, a suspect variant, a novel variant, or a non-suspect variant. The characteristic of the variant can be represented by any indicia, as described herein.

The present invention has several advantages. By merging the informatively distinctive data on sequence variants found in a given genome (or set of genomes) with previously established understanding of mechanistic and/or causal interactions between variant-associated biological objects, such as genes, proteins, or diseases, the present invention synergistically provides insights into how individual sequence data relates to more general biological relational network data.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a screen output providing a display in which the user searches for and the user application displays an individual's genetic variants overlaid onto gene relational networks. In this figure, the user found 20 gene relational networks related to methamphetamine-related phenotypes, each ready for display including variants found in the individual's (subject SG1072) genome.

FIG. 2 is a screen output of a graphical user interface configured to provide the user with additional parameters for searching and obtaining relational networks related to cancer. In this figure, the user searched for networks that each contains at least 2 genes in which the chosen subject genome(s) (e.g., SG1571 but not SG1570) carry particular classes of variant(s). The user also specified the maximum number of genes in networks by 50 genes to tailor the size of your networks to be within a given limit.

FIG. 3 is a screen output providing a display in which the user selects the ARRB2 gene network and the software displays 37 genes within that network, including genotypic variants found in the individual. Black and red nodes represent genes in which the subject genome has at least one homozygous suspect variant, or more than one heterozygous suspect variant in the individual's genome; red nodes represent genes in which the subject genome has one heterozygous suspect variant; orange nodes represent genes in which the subject genome has no suspect variant, but at least one missense variant; and gray nodes represent genes in which the subject genome has no suspect or missense variant. Green-haloed nodes represent genes in which the subject genome has at least one novel variant of the class that defines the node's core coloring (i.e., orange, red, or black and red) in the genome in question.

FIG. 3A-3D summarize the mix of variants found in a gene-gene interaction network in Genome 1 (3A) and Genome 2 (3B) respectively; the same interaction network summarizing the least-suspect composition of variants found in either of the two genomes (3C); and the same interaction network summarizing the most-suspect per-gene composition found in either of the two genomes. That is, FIG. 3A is schematic showing a gene-gene interaction network in Genome 1, whereas FIG. 3B is a schematic showing a gene-gene interaction network in Genome 2. FIG. 3C is a schematic showing relational networks that are common between the two genomes where the commonality is represented using the least suspect composition found in any of the common networks between the genomes. FIG. 3D is a schematic showing relational networks cumulatively for variants present in both genomes where the nodes are colored to denote the most suspect variant composition found in any of the unioned genomes. The color scheme described in FIG. 3 is used.

FIG. 4 is a screen output providing a display in which the user clicked on the ARRB2 gene, which is colored green-haloed red, meaning that the subject genome has exactly one novel (green halo) heterozygous suspect variant (red) in this gene. The display also provides individual variant information for this gene.

FIG. 5 is a screen output providing a display in which the user expands the ARRB2 gene interaction network to show the other neighbor genes of gene OPRD 1 (those that are not direct neighbors of ARRB2 itself), where the OPRD1 gene is colored red-black, meaning the subject genome has at least one homozygous, or multiple heterozygous, suspect variants in that gene; the result is a neighbor network which shows yet another gene in which the subject genomes has a suspect variant, enriching the informational context of the originally selected network.

FIG. 6 is a screen output providing a display in which the user highlights explores the subclasses of variants that make up the main node color-specifying classes; in this case, the user has chosen to highlight only genes that harbor either at least one phenotype-implicated variant, or at least one non-phenotype-implicated missense variant, in the subject genome. All nodes that do not meet these criteria have been blurred out.

FIG. 7 is a block diagram of an embodiment of the system of the present invention. The system depicted in FIG. 7, includes a client terminal and a plurality of remote servers. The client terminal is operatively coupled to a processing module, communication interface, I/O interface, and a memory module. The memory module depicted in FIG. 7 includes a user application and an annotated database. The processing module can be a single processing module, a plurality of processing module, or combinations thereof. The communication interface allows the user application, other software/programs, and data to be transferred between the client terminal and other components described herein. Communications interface can include a modem, a network interface (such as an Ethernet card), a communications port, a PCMCIA slot and card, or the like. Software/program and data transferred via communications interface may be in the form of signals, which may be electronic, electromagnetic, optical, or other signals capable of being received by communications interface. I/O interface allows the user to interact with the user application. Any input devices, such as keyboard, mouse, or touch screen coupled with additional human computer interaction software can be used to receive input from the user. I/O interface can also include, for example without limitation, monitor, television, screen, printer and the like. In this document, the terms “display” and “graphical user interface” are used to generally refer to screen output presented via I/O interface. The memory module can include main memory, for example, random access memory (RAM), and can also include a secondary memory. Secondary memory can include, for example, a hard disk drive, removable storage drive, or any other non-volatile storage medium. Although the user application and the annotated database are implemented in a single memory module of a computer system, various other implementations can be adopted. For instance, the user application and the annotated database can be implemented using multiple computer systems. Further, the user application, the annotated database, or both can be implemented in one or more remote servers.

### DETAILED DESCRIPTION OF THE INVENTION

A description of preferred embodiments of the invention follows. The present invention relates to a computer system, apparatus and methods for providing a visual overlay of individual genome sequence data onto biological relational networks. By symbolically projecting one or more of the sequence variants found in one or more given genomes onto a relational network, one can highlight clusters of variants that can strongly interact in governing the physiology of the individual.

The relational network, as referred to herein, is defined as a graph comprising one or more nodes connected by line segments (edges) to one or more other nodes. In certain cases, a node can, but need not, have any edges. In practice, the relational network represents putative functional links between variant-associated biological objects, such as genes or diseases, as summarized in generic public and other databases. Biological objects are defined herein as genotypic or phenotypic entities that relate to one or more genome sequence variants or to at least one other such entity. Examples of such biological objects include genes, regulatory regions, promoters, enhancers, insulators, metabolites, diseases, proteins, functional RNA molecules, and other macromolecules made by organisms. Biological objects of the present invention can be any genotypic or phenotypic information that relate to genome sequence variants, and can be represented by the relational networks. Sequence variants, also referred to as “variants” as used herein, include all variant spellings (e.g., the polymeric units of DNA (A,C,G,T) or RNA (A,C,G,U)) of a given segment of a genome shared by members of a population of organisms.

Information on biological objects can be obtained from various publicly databases (e.g., PubMed database, the HPRD database (http://www.hprd.org/)) or other informational sources. In an aspect, the present invention provides relational networks that use information about variants from one or more references found in a publicly available database. Also, in an aspect, the present invention maps an individual's genetic variants to relational networks of phenotypic information or other biological objects that are inherently related to the variant (e.g., by harboring the genomic site of variation in question), wherein the information for the relational network is obtained from publically available sources.

To obtain an individual's genetic information, a sample (e.g., blood, saliva, semen, serum, urine, or other cellular material) containing deoxyribonucleic acid (DNA) is taken from the individual. DNA is genetic information that is stored as a code made up of four chemical bases: adenine (A), guanine (G), cytosine (C), and thymine (T). Generally, human DNA consists of about 6 billion bases per cell, and more than 98 percent of those bases are the same in all people of a given sex (and between people of distinct sex, throughout all the genome except the X and Y chromosomes). The sample is prepared and the DNA is extracted from the cells and processed according to well established protocols. Sequencing can be done by a laboratory using conventional (e.g., Sanger) or/and high-throughput short-read (‘next generation’) methods. Examples of genomic sequencers include the 454 Genome Sequencer FLX (454 Life Sciences/Roche Applied Science, Branford, Conn., USA), the Illumina Genome Analyzer, powered by Solexa® (Illumina, Inc San Diego, Calif., USA) and the SOLiD™ system (Applied Biosystems by Life Tecnologies, Carlsbad, Calif. USA), HeliScope™ single molecule sequencer (Helicos BioSciences Corporation Cambridge, Mass. USA) and CEQ TM 8000 (Beckman Coulter, Inc. Brea, Calif. USA). Sequencing techniques known in the art or later developed can be used with the methods and systems of the present invention. To increase the rate at which the DNA is sequenced, the DNA is digested and sequenced in smaller pieces and then reassembled.

The sequencers provide a digital genome. The digital genome is a reasonable and accurate representation of the individual's DNA. Laboratories that sequence the DNA can be Clinical Laboratory Improvement Amendments (CLIA)-certified. Sequence analysis is often redundant with overlap (e.g., sequencing the DNA more than once and sequencing overlapping sections of the DNA and verifying the sequence) to ensure accuracy. The sequence data (‘reads’, each representing one fragment of the genome being sequenced) is then computationally aligned and assembled, yielding a “digital” representation of the genome.

The digital genome is compared to a reference genome (e.g. the Reference Human Genome, NCBI Build 37, www.ncbi.nlm.nih.gov/projects/genome/assembly/grc/human/index.shtml) and their mutual matches and mismatches are recorded in a database. These matches and mismatches are the individual's genetic variants. The dataset includes a number of genotypes for variable sites (e.g., sites in the genome that are known to vary in spelling from one copy of a given chromosome to the next) extracted from one or more genomes. In an embodiment, one or more genomes refer to the genomes of individuals or genomes from different tissues from the same individual. Accordingly, in an embodiment, a genome can be from an individual having (‘affected’)—or not having (‘control’)—a studied phenotype (e.g., a particular disease). Additionally, in another embodiment of the present invention can utilize genomes from different tissues from the same person, e.g. tumor tissue and healthy tissue.

The individual's genotypic data is filtered. Sites where the variants were not confidently discerned are omitted, and the user application of the present invention described herein generates an output with one or more visualizations or representations that allow the user see the similarities and differences in the genotypes of the sites that remain after filtering. Accordingly, in an embodiment, the user application filters the data to eliminate certain genetic sites, and determines, depending on the type of analysis, which visualizations of similarity and difference to offer. More specifically, the individual's genetic data is filtered by eliminating non-variable sites (that is, those that have shown the same sequence in all individuals studied, to the best knowledge of the software maker). The user application then filters out variable sites that are not located in genes, gene-regulating segments, or other contiguous or dispersed genome segments of interest. The type of variant that remains after the filtering process and/or is represented in the display is one that is either (a) a genotype at a variable site, or (b) a set of genotypes at different variable sites (as in a “genoset”). In an embodiment, the notable variants are those that are present in all, most, or many of the “affected” individuals, but are absent or present in only few of the “control” individuals.

In another embodiment, the present invention involves deploying an annotated database that contains an individual's genetic variants along with relational networks information about one or more variant-associated biological objects. The individual dataset containing information about the variant is overlaid onto relational networks of biological objects. The annotation of the dataset can include assessment of the exact DNA sequence(s) found at a given position in a given subject genome, as well as other ancillary information. The annotated dataset can include the specific DNA bases (e.g., As, Ts, Cs, Gs) at that position (e.g., a determination if that specific base sequence(s) at that position is/are the same, or if they differ from a representative reference sequence, what the difference is). In addition, the annotated dataset can further include information about the relational networks and the associated biological objects for the variant.

As described herein, the annotated dataset is processed by a processing module to display in which only relational networks for the individual's genetic variant appear as part of the display. The methods of the present invention are a powerful tool to focus and direct the user's attention on biological networks relevant to the variants in the subject's genome and to visually present biological object information of the relational network of variants for that specific individual.

Specifically, in the current embodiment, an individual's genetic variants, which can be associated with phenotypes, such as diseases, conditions, symptoms, or innocuous traits) are implicitly displayed using relational networks that represent interaction or co-expression (under particular conditions) of proteins encoded by genes that harbor the variants in question, where the color or other visually distinctive properties of nodes, each representing a gene, convey what kinds of variant(s) (in well established terms that reflect variant-specific effects on protein sequence and/or function) that gene harbors in a chosen individual.

The data and/or dataset described in the embodiments of the present invention can be provided on a digital storage medium, for use in the methods described herein. A digital storage medium is a format on which digital information can be stored or saved. Examples of storage mediums include local or distributed (‘Cloud’) servers, primary storage devices (e.g., any type of random access memory) and secondary storage devices (e.g., portable hard drives, internal hard drives, external hard drives, SD card, CF card, flash drives, any non-volatile storage media, CDs, DVDs, Blue Ray discs, any optical storage devices, tapes, ZIP disks, any magnetic storage devices, nano-technological storage device, and the like. Such storage mediums can be operatively coupled to a client terminal, a centralized remote server, a plurality of remote servers forming a distributed network system(s), or any combination thereof. As used herein, a “database” is a collection of two or more pieces of stored data or dataset in predetermined data index architecture. Data can be stored and indexed in data index architecture or in manner, and in a mode known in the art, or developed in the future. Examples of types of databases that store data and links described herein include PostGreSQL, H2, MySQL, SQLite, and Oracle. The data can be stored physically together, or associated with one another. A person of ordinary skill in the art would recognize that, in some embodiments, each of the data/dataset can be implemented in separate databases, using multiple servers so as to improve reliability, speed, or other factors.

Once the data are filtered and annotated, the individual's genetic variant information can be used with the methods of the present invention to detail genotypes at the remaining variable sites for a single subject overlaid onto one or more gene networks, wherein the gene network is based on known interactions between the proteins.

Additionally, some embodiments of the present invention allow a user to highlight genotypes that meet a combination of additional criteria. This selection of additional criteria, which is further described herein, allows a user to further filter or eliminate genotypes at other variant sites. Examples of such criteria implemented include homozygous/heterozygous variants, known genotype-phenotype association, position within a splice-site region, functional class of difference from the reference sequence (e.g., frameshift, nonsense, missense, etc.), predicted effect on protein function (function-changing, tolerated, etc.), and novelty (e.g., having never before been documented in any genome from the same species/population).

More specifically, in an embodiment, relational networks appear with nodes colored to indicate the class(es) of variants found in each gene in the subject genome in question. One class of variant is a protein changing variant, which alters a protein, relative to the version of that protein encoded by the human reference sequence. In an embodiment, protein-changing variants can be missense (e.g., substituting one amino acid for another), nonsense (e.g., substituting a stop residue for an amino acid), read-through (e.g., substituting an amino acid for a stop residue), frameshift (e.g., yielding a reading frame that differs from that of the reference), or splice-changing (e.g., ‘splice region’, yielding a protein product that can translate sequence in an intron of the reference version of the gene, or omit exon sequence found in the reference version of the gene). Note that a protein-changing variant may or may not also be a protein sequence-disrupting variant. A protein sequence-disrupting variant is one that significantly alters a protein, relative to the version of that protein encoded by the human reference sequence. Accordingly, all protein sequence-disrupting variants are also protein-changing, but not vice versa. Protein-changing variants can be nonsense, read-through, frameshift, or splice-changing.

Another class of a variant includes a phenotype-implicated variant, which is a variant that reportedly confers unusual odds for some disease or other phenotype in publicly reported research. Genotype-specific phenotypic odds ratio estimates can also be obtained. In an aspect, a phenotype-implicated variant can confer phenotypic odds that are above or/and below those estimated for people with other genotypes. However, if no site-specific genotype has been reported to confer odds >6/5 or <5/6 times the odds conferred by some other genotype at that site, for any phenotype, then in certain embodiments of the present invention, no subject genome will be reported to carry a phenotype-implicated variant at that site. Note that, in certain aspects, a phenotype-implicated variant may be a reference variant, and, even if not a reference variant, may not be protein-changing.

In addition, a predicted function-changing variant is another class of variants. Such a variant is predicted to significantly affect the function of the protein that expresses it, relative to the version of the protein encoded by the human reference sequence. If missense, such a variant was predicted by the SIFT algorithm to be ‘damaging’ (e.g., ‘function-changing’), with low or high confidence. By default, embodiments of the present invention include predicting nonsense, read-through, frameshift, and splice-changing variants to be function-changing variants.

On the other hand, a predicted tolerated variant is not predicted to significantly affect the function of the protein that expresses it, relative to the version of the protein encoded by the human reference sequence. If missense, such a variant was predicted by the SIFT algorithm to be ‘tolerated’, ‘not scored’, or ‘N/A’. Furthermore, in an aspect, a variant that is neither protein-changing nor phenotype-implicated is considered of type ‘Other’. Within a protein-coding gene, such a variant can be synonymous (if within a codon), exonic non-coding, intronic, or in 5′ or 3′ untranscribed regions (UTRs).

Moreover, other embodiments of the present invention allow flexible filter-based searches for networks that meet user-specified criteria (such as networks harboring more than a given number/density of certain kinds of sequence variants), wherein the user can help rank networks by potential interest to a given user studying a particular genome. The user can search for any information stored in the annotated database including gene information, phenotypic information, diseases, conditions, treatments, drugs, and the like. In a certain example, the user can search for a gene or disease.

In one aspect, the present invention relates to methods for analyzing or viewing the genomic data of one or more genomes. The system allows the user to find relational networks based on any information in the network, such as gene name, phenotype, variant composition (sorted by degree of suspectness, defined in biologically sensible ways), and the like. When the user enters a search string, all relational networks for variants with relevant annotation data responsive to the search string are returned (for display or other use) for one or more genomes. The returned information can be presented to the user, or processed further for other uses. As described herein, in an embodiment, the returned information can be visually presented to the user. The display can contain relational networks that are common to all genomes in a given dataset. In one embodiment, the nodes of the relational network can be represented by the least suspect variant content found in any of the genomes under comparison. In another embodiment, the aggregate of relational networks for all genomes can be shown, representing each node by the most suspect variant content found in any of the genomes under comparison. The methods of the present invention are well suited for comparing a group of genomes in which some or all individuals manifest a particular disease or other phenotype of interest. Accordingly, a group of individuals having a rare genetic disease can be assessed for common variants, and a visual display of relational networks common among the group can be displayed along with characteristics of the variants (e.g., suspect, novel, missense, etc.). In another embodiment, a group of genomes from individuals exhibiting a certain phenotype can be compared to a group that does not exhibit the phenotype to ascertain differences in relational network variants between the groups to determine variants causing the phenotype.

In an embodiment, each relational network is either a focal gene network that includes one focal gene, for which the network is named, and all of its encoded protein's interaction neighbors, as annotated by HPRD, or an annotated network having one or more genes jointly implicated in a particular phenotype, for which the network is named, as annotated by the MSigDB portion of HPRD. HPRD-annotated protein-protein interactions are supported by various kinds of evidence.

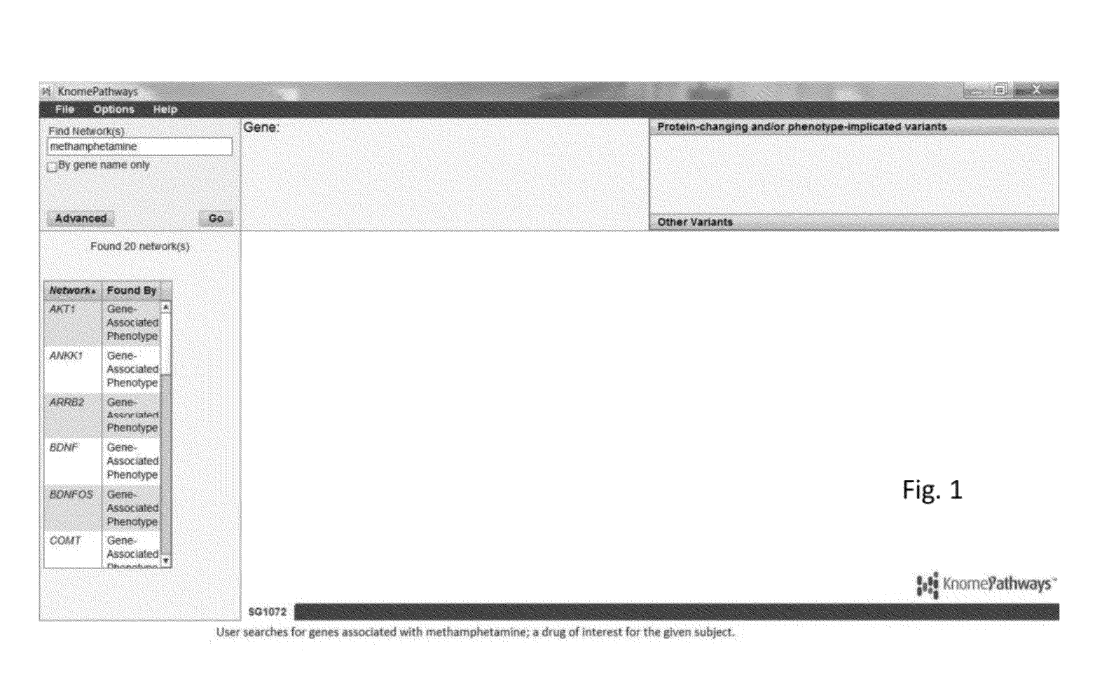

Referring to FIG. 1, an example of the display or graphical user interface (“GUI”) of the present invention is shown. The interface is configured to interact with a user and provide a visual overlay of individual genome sequence data onto biological relational networks is provided. As depicted in FIG. 1, the GUI is provided with a text field for a user to enter the criteria of interest to ascertain if the user's individual's genetic information contains variants related to the criteria of interest. The criteria of interest which the user can enter into the provided field include, for example, all or part of a gene name, phenotype, a biological object, or a network annotation term. The GUI is provided with a button for initiation the search (e.g., GO button as shown in FIG. 1). When the user initiates the search, the system described in the present disclosure generates a query to search one or more databases (e.g., annotated database) to obtain matching information. The query can be optimized to minimize the number of unwanted matches. For example, the user can be provided with an option, such as “by gene name only” option as shown in FIG. 1, to avoid unwanted matches being returned like “THE”.

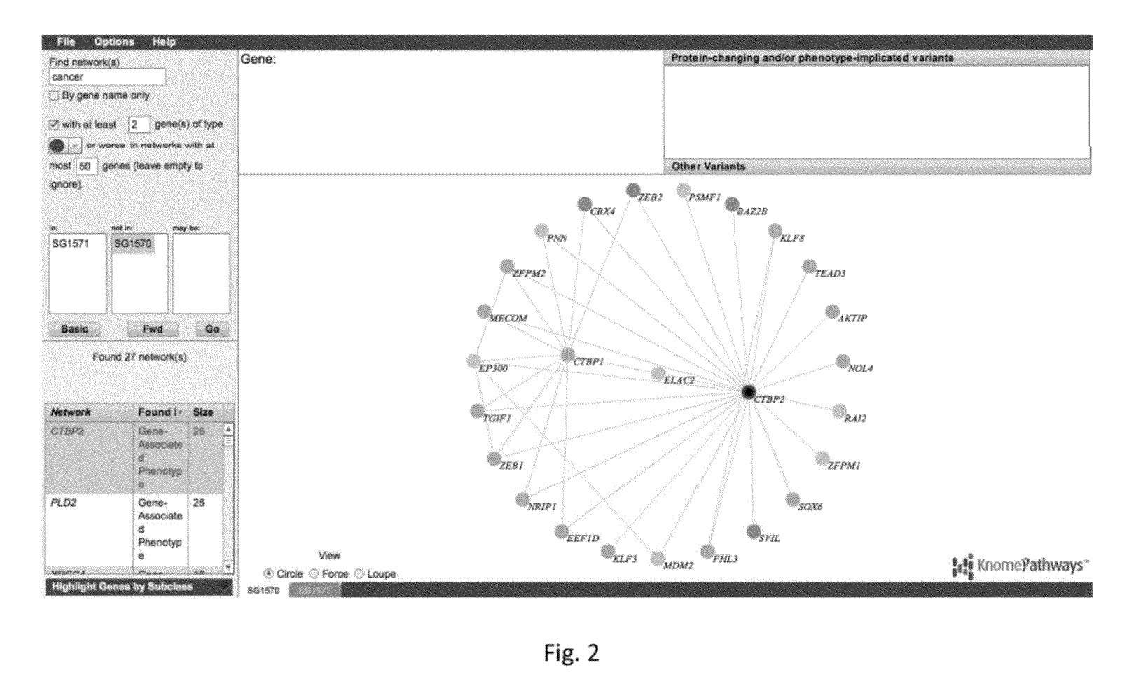

Referring to FIG. 1, the user is also provided with an advanced search button to adjust additional parameters for making the search more precise and obtain networks that meet particular criteria. For example, in FIG. 2, the user can search for networks that each contain at least some number of genes (e.g., 2 as shown in FIG. 2) in which one or more chosen subject genome(s) (e.g., SG1571 but not SG1570) carry particular class(es) of variant(s). The variants can be defined, for example, by gene-specific node color scheme. Furthermore, in an embodiment, the user can also specify the maximum number of genes in networks (e.g., “networks at most 50 genes” as shown in FIG. 2) to tailor the size of your networks to be within a given limit. Such option is particularly useful when the user wants to ensure the number of genes within the specified variant class occur in networks of relative size. As depicted in FIG. 2, when dealing with multiple subject genomes, a plurality of lists like “in”, “not in” and “may be” list can be provided for the user to specify, respectively, in which genomes the other chosen criteria must, or must not, or hold. Referring back to FIG. 1, the user searched for “methamphetamine” to assess if the individual's genetic information relates to or is associated with relational networks having a biological object that relates to the drug, and a list of relational networks having a biological object relating to methamphetamine is provided in the lower left pane of the screen. The networks can be resorted by name or size, but by default are sorted by match type (‘Found by’). The match type includes, for example, “focal gene” or the name of the focal gene of the network partly or wholly matches the search term. Match types can also be a “gene-associated phenotype” which refers to a focal gene of the network that is implicated in a phenotype that partly or wholly matches the search term. Other match types include a “network annotation” that is text partly or wholly matches the search term, and “contains gene” which refers to a network that contains a gene whose name partly or wholly matches the search term. As shown in FIG. 1, the following networks were found: AKT1, ANKK1, ARRB2, BDNF, BDNFOS, COMT, etc. In this case, the biological objects of the relational networks are genes that encode proteins that, per publicly reported research, have been studied or implicated in phenotypes involving methamphetamine (such as methamphetamine addiction).

Referring to FIG. 2, when the user clicks on a network in the network list, the graphical representation of the chosen network is displayed in the main display pane of the screen. By default, the canvas will first show the first subject genome (e.g., SG1570 as shown in FIG. 2) overlaid on the selected network. When multiple subject genomes exist, buttons or selectable tabs as shown in FIG. 2, can be provided on the GUI for the user to switch from one subject genome to another and see how a chosen network differs between the subject genomes.

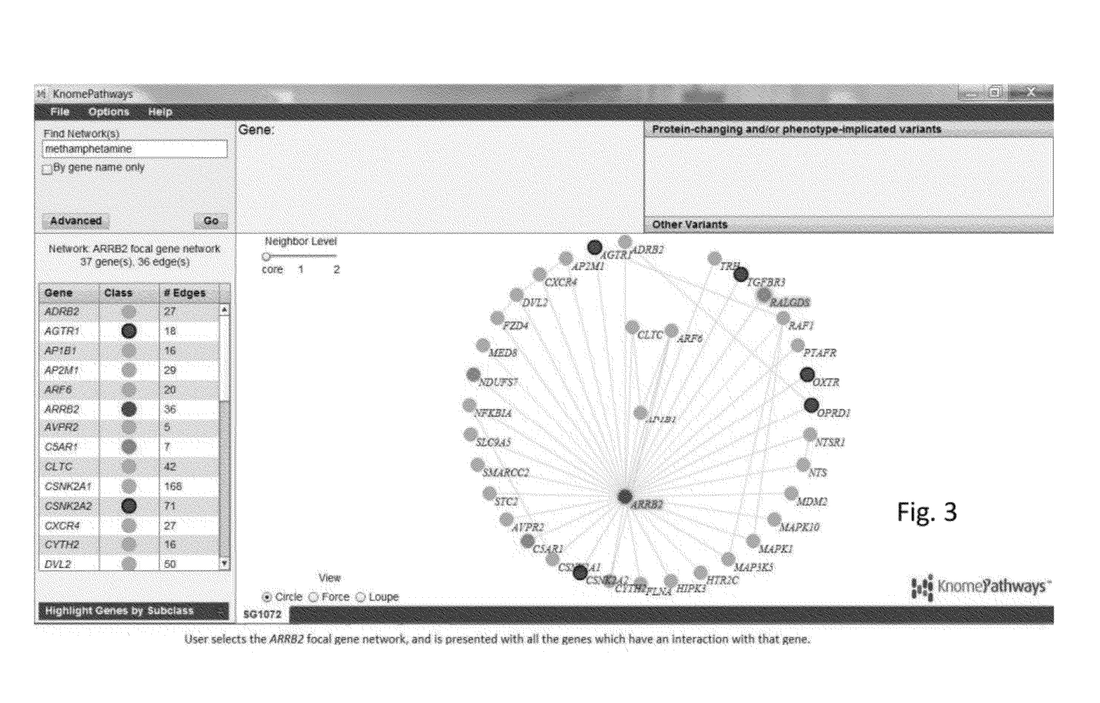

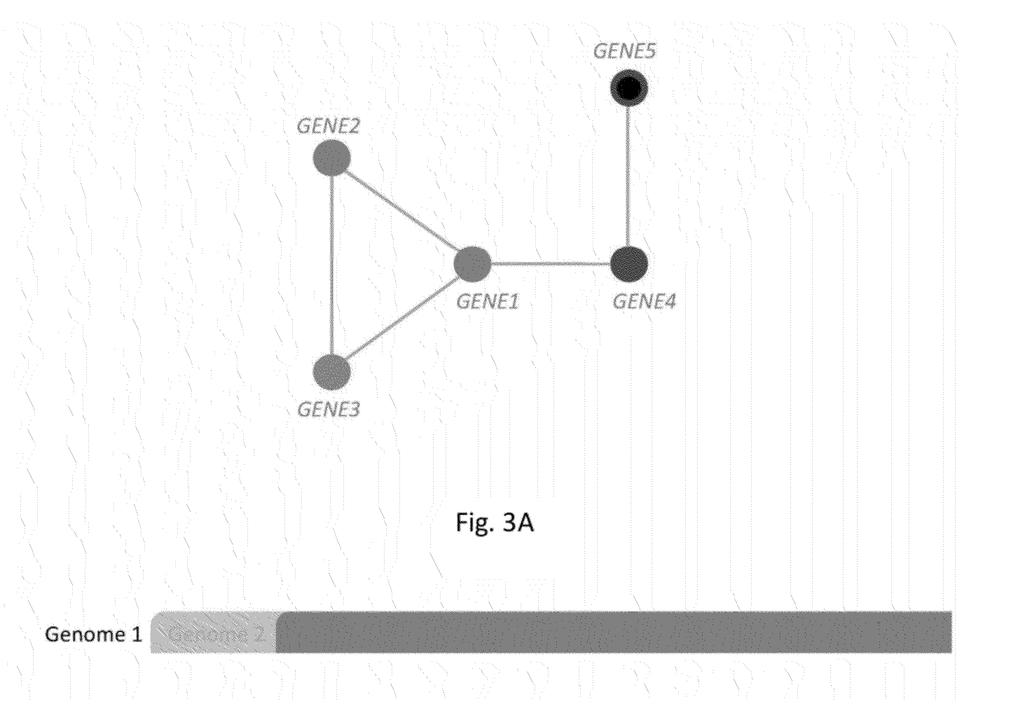

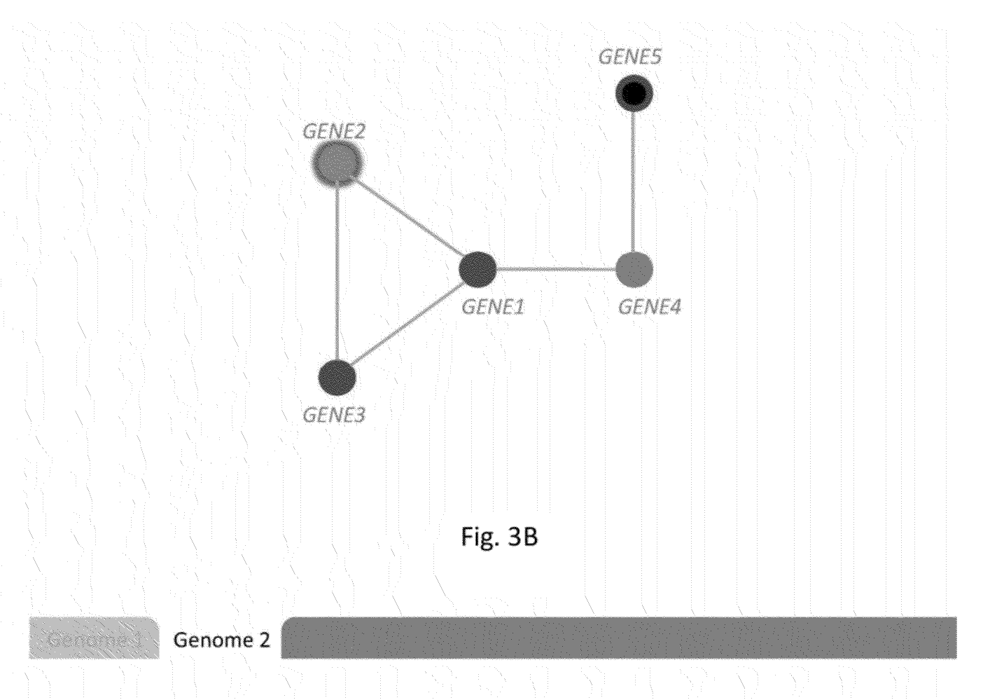

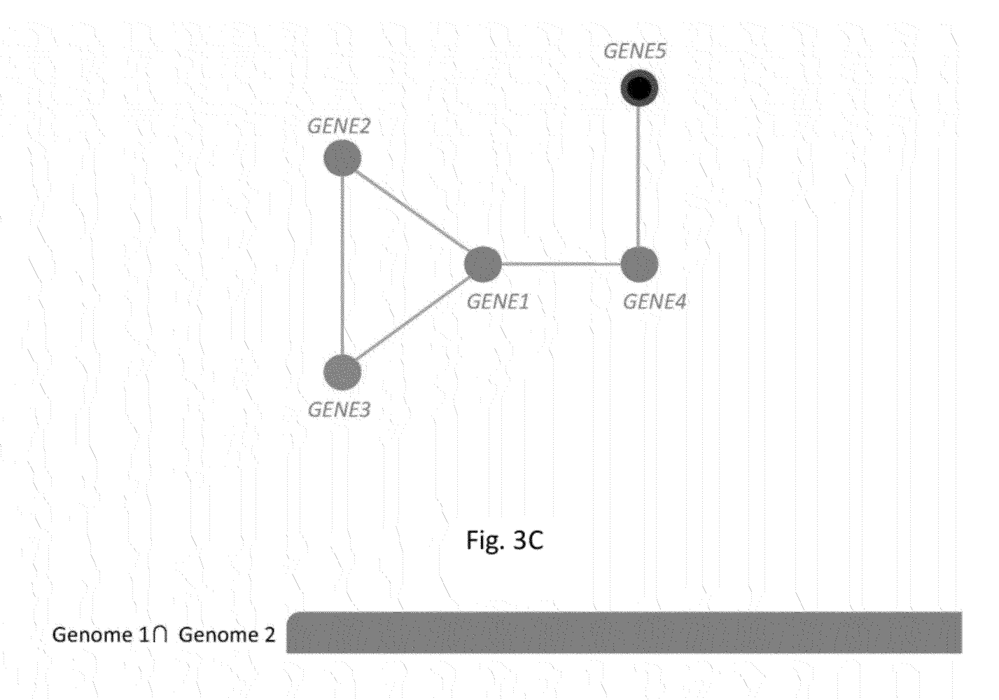

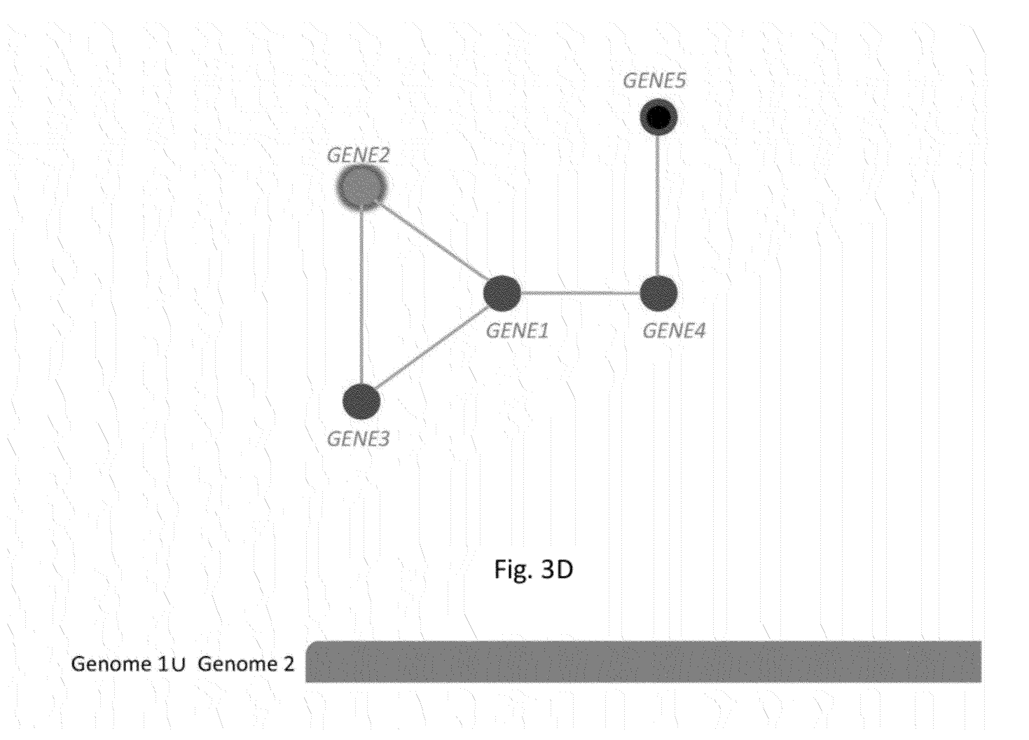

In FIG. 3, the user chooses one of the genes, namely, ARRB2, and the user is presented with a visual representation of all genes that interact with ARRB2 that are found in the individual's genome. Individual data is displayed in the context of its relationship to the relational network e.g., in the form of a potentially reticulate node-edge graph.

In a simpler exemplary schematic shown in FIG. 3A, a gene-gene interaction relational network for an individual's genome, Genome 1, is shown. In this case, nodes are genes, connected by edges that represent empirically reported pairwise interactions between respective gene products (e.g., proteins) reported in public reference data. Node color denotes the composition of variants in that gene found in the individual's genome, Genome 1. In FIG. 3A, the following color scheme was assigned: red-ringed-black (black-and-red) nodes were found to carry at least one homozygous, more than one heterozygous, or more than one heterozygous protein sequence-disrupting (i.e., nonsense, read-through, frameshift, or splice region) or suspect variant in the individual's genome; red nodes were found to carry exactly one heterozygous suspect or protein-sequence disrupting variant in the individual's genome; orange nodes were found to carry no suspect or protein sequence-disrupting variants, but at least one heterozygous or homozygous predicted missense variant was found in the individual's genome; all other nodes are gray. Gray nodes represent a gene with no protein sequence-disrupting variant, a variant that is not suspect or missense,or phenotype-implicated variant in the chosen subject genome. Although not shown in this figure, in an embodiment, yellow nodes can be used to represent a gene with one or more heterozygous or homozygous predicted tolerated missense variant(s), and/or one or more heterozygous or homozygous phenotype-implicated variant(s) (which may or may not be protein-changing), but no protein sequence-disrupting or predicted function-changing variant in the chosen subject genome. Any graphical representation can be used to represent the nature or characteristic of the variant including a color scheme, shapes, symbols, characters or any other indicia to represent the nature of the variant found in the individual's genome. For example, instead of a “circle” with various colors associated with the characteristic of the variant, the color scheme can be substituted with shapes (e.g., squares, triangles) that convey characteristics of the variant. Any characteristic of the variant can also be displayed graphically using similar graphical representations described above. Characteristics of the variant can include, for example, one or more heterozygous variants, one or more homozygous variants, a missense variant, a suspect variant, a novel variant, a non-suspect variant, or any combination thereof. Not just a color, but a symbol, such as a question mark inside the node, can be used to represents a gene in which no sites were called, for example, a gene that was not covered well enough in sequencing to confidently call any sites) in the chosen subject genome. In an aspect, such a gene can have simply been poorly covered by chance or systematic technical bias, or can be absent, perhaps due to homozygous deletion, in the subject genome in question.

FIG. 3B shows the same gene-gene interaction network in another individual's genome, Genome 2. In addition to the color scheme described for FIG. 3A, green-haloed nodes depicted in FIG. 3B represents genes that carry at least one novel variant of the class that defines the node's core coloring (i.e., orange, red, or black-and-red) in the genome in question. Novel variants are those that are not previously found in any human genome according to publically available information. In some embodiments, gray nodes are not green-haloed, whether or not they harbor novel variants because such variants are not deemed ‘interesting’ enough to warrant highlighting by color e.g., do not meet the criteria used for the coloring scheme. A gene with novel variants could be grey because any novel variants it contains are not predicted to affect the sequence or function of the protein produced by the gene that harbors it, or any other gene. In other words, the gene is a novel variant that is “synonymous” with the “normal” recipe, and not implicated in any phenotype.

FIG. 3C shows the same gene-gene interaction network upon ‘intersecting’ genomes 1 and 2. FIG. 3C shows common variant nodes of the two genomes. Such an analysis easily allows one to view commonality among more than one set of individual's genomic variants in the context of relational networks of biological objects. In this case, nodes are colored to denote the least suspect composition found in any of the intersected genomes. The degree to which the variant is suspect is graded as follows: Green-haloed black-and-red coloring is deemed most suspect, and in order of decreasing degree; plain black-and-red coloring, green-haloed red coloring, plain red coloring, green-haloed orange coloring, plain orange coloring, and gray coloring. As such, if a node was colored gray in one genome and red in another, for example, that node is colored gray in the intersected view.

In contrast, FIG. 3D provides a view in which the combination of the two genomes is shown. FIG. 3D shows the same gene-gene interaction network by providing a union of genomes 1 and 2. Nodes are colored to denote the most suspect variant composition found in any of the combined genomes. As such, if a node was colored gray in one genome and red in another, for example, that node is colored red in the combined view.

In light of the foregoing color scheme, the user in FIG. 3 selected the ARRB2 focal gene network and is presented with all genes that encode a protein that interact with the protein encoded by ARRB2. In this case, there are 36 edges from the ARRB2 node to other related genes. An indicia of the degree to which the variant is suspect is provided using the color scheme, so that the user can easily and quickly ascertain which of the individual's genes contain suspect variants and relate to an interaction with methamphetamine. In this exemplary screenshot shown in FIG. 3, a list of gene networks that interact with ARRB2 (e.g., 37) is provided along with the number of edges in the graph (e.g., 36) that shows the relationship ARRB2 has with other gene networks. The user can modify the neighbor level of the networks by choosing “core”, “1” or “2”. The degree of closeness relates to the number of reticulations or lines between nodes. The lesser number of reticulations, the closer the relationship between the networks, whereas the greater number of reticulations indicates a more distant connection or degree of relatedness. In addition, the genes that encode proteins in that network are listed in the list box as shown in FIG. 3. Genes can be resorted by associated node color or edge count (i.e., the total number of edges that a gene has in its own focal network), but by default are sorted by name as illustrated in FIG. 3.

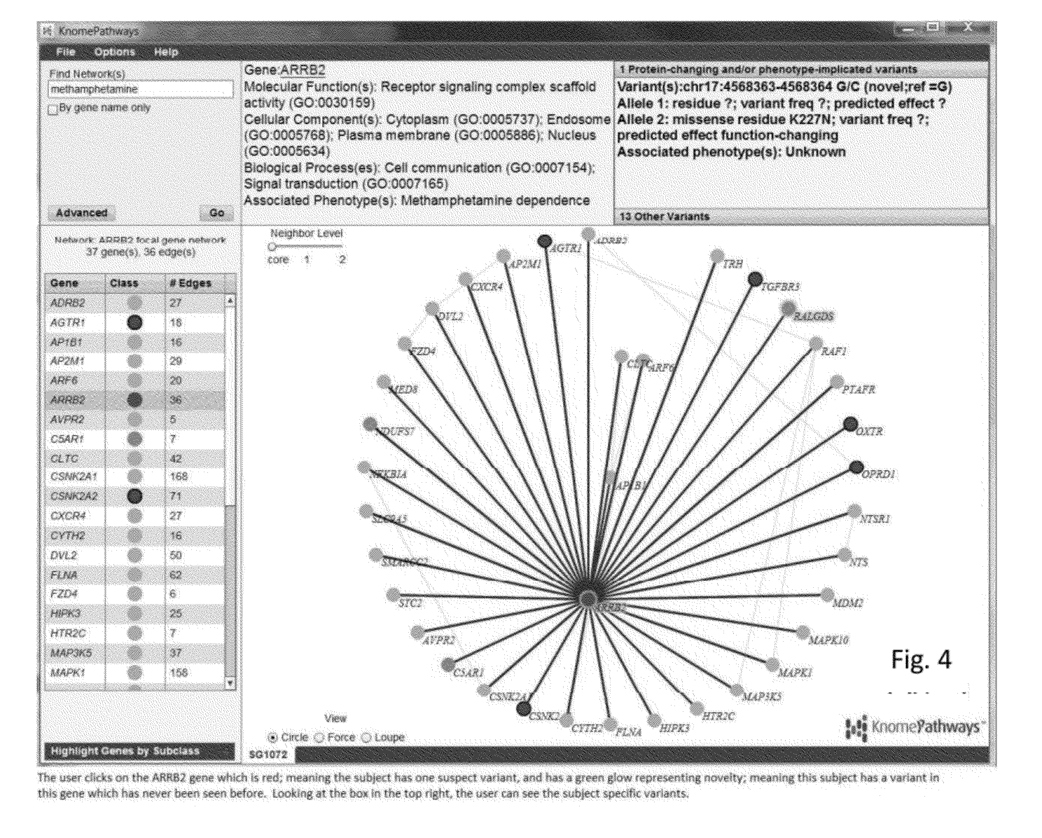

When the user clicks on the ARRB2 gene in the gene list box, additional information about the gene and the variant is provided. See FIG. 4. In this case, the ARRB2 gene is red, meaning the subject has one suspect variant, and has a green halo which meaning the gene harbors a novel variant, a variant that has not been seen before. When the user clicks on the ARRB2 gene in the list, its node and edges in the network are highlighted, and load its reference and subject genome-specific data into, respectively, the “Gene:” and subject genome data boxes as shown in FIG. 4. Gene-specific reference data include gene name, Gene Ontology (“GO”) terms, which in an embodiment can be provided as hyperlinks to further informational sources on the terms, and gene-associated phenotypes, e.g., information which can be obtain from the annotated database or a publicly available databases). In the upper right box, the user can view the subject's specific variant information. Subject genome-specific data include chromosome and position (e.g., space-based coordinates on the forward strand), dbSNP-defined rs number of allelism at that site, reference variant (ref), and details on each allele in the chosen subject genome: variant class (synonymous, missense, nonsense, etc.), protein residue notation (e.g., S123S for a synonymous serine-encoding variant at residue 123; K456N for an asparagine-encoding variant instead of a reference-encoded lysine at residue 456), variant frequency (in the reference population to which the subject genome best belongs; novel variants have ‘novel’), predicted effect on protein function (by SIFT, etc., if applicable), and associated phenotype(s) with links directly to underlying PubMed-curated research reference(s).

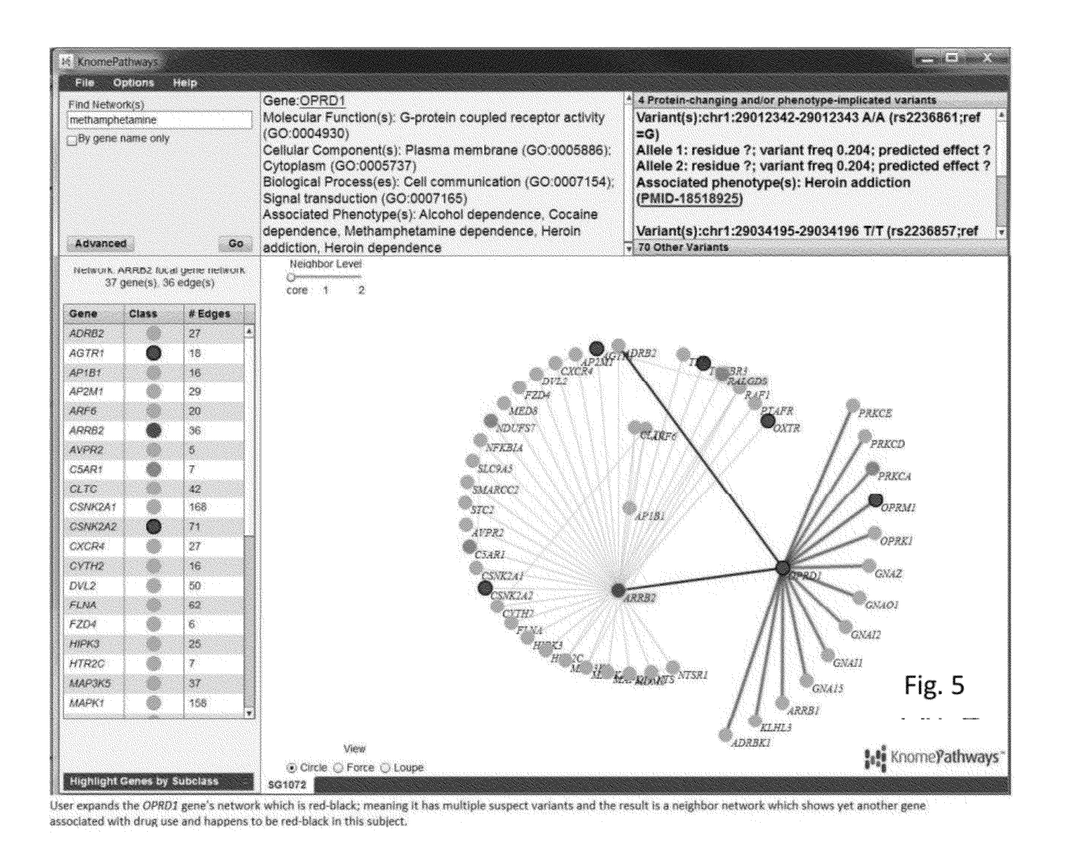

The user can interact with the network provided on the screen. For example, in an embodiment, placing a mouse cursor over a node can be configured to provide the name of the gene it represents, and how many protein-changing/phenotype-implicated variants (and other variants) it carries in the chosen subject genome. The user can also click on a node to view the selected gene's reference data, and details on the protein-changing and/or phenotype-implicated variants that it carries in the chosen subject genome. Additional buttons on the GUI can configured for the user to see other variants (e.g., “Other Variants” button shown in FIG. 5) or return to the previous view (e.g., Protein-changing and/or phenotype-implicated variants). FIG. 5 is an exemplary illustration of an embodiment showing a view in which the user clicks on a node representing a gene, OPRD1, which is itself a member of a large network. This gene is in red-ringed-black, meaning it has multiple suspect variants. When the user clicks on the OPRD1 gene, a neighboring network which shows yet another gene associated with methamphetamine, namely OPRM1 which is also red-ringed-black is displayed. In an embodiment, the edges of the neighboring network can be illustrated differently from the edges of the original network to help the user distinguish the networks. FIG. 5 shows a number of suspect variants in the individual in methamphetamine-related gene networks. The output generates a display that provides updated information about the OPRM1 variant in the upper right box along with information about the OPRD1 gene in the upper middle box.

In an embodiment of the present invention, relational networks appear in the radial view by default, with hub genes (e.g., focal genes in focal gene networks) near the center and other genes in a ring as illustrated in FIG. 4. Nodes can be dragged to open space as illustrated in FIG. 5. Furthermore, in some embodiments, the network can be illustrated in many other ways. For example, the user can click the force button to switch to an energy-minimizing view in which the sum force on each node is proportional to how many edges it has. Such view is most useful for spreading out dense networks, or for spotting hub nodes in sparse networks. Also, the user can click the loupe button to switch to a locally zooming view, useful for picking out particular nodes in dense networks while retaining a radial-like view. Additional views of the network can be used to summarize biological relational networks in various other context as appropriate.

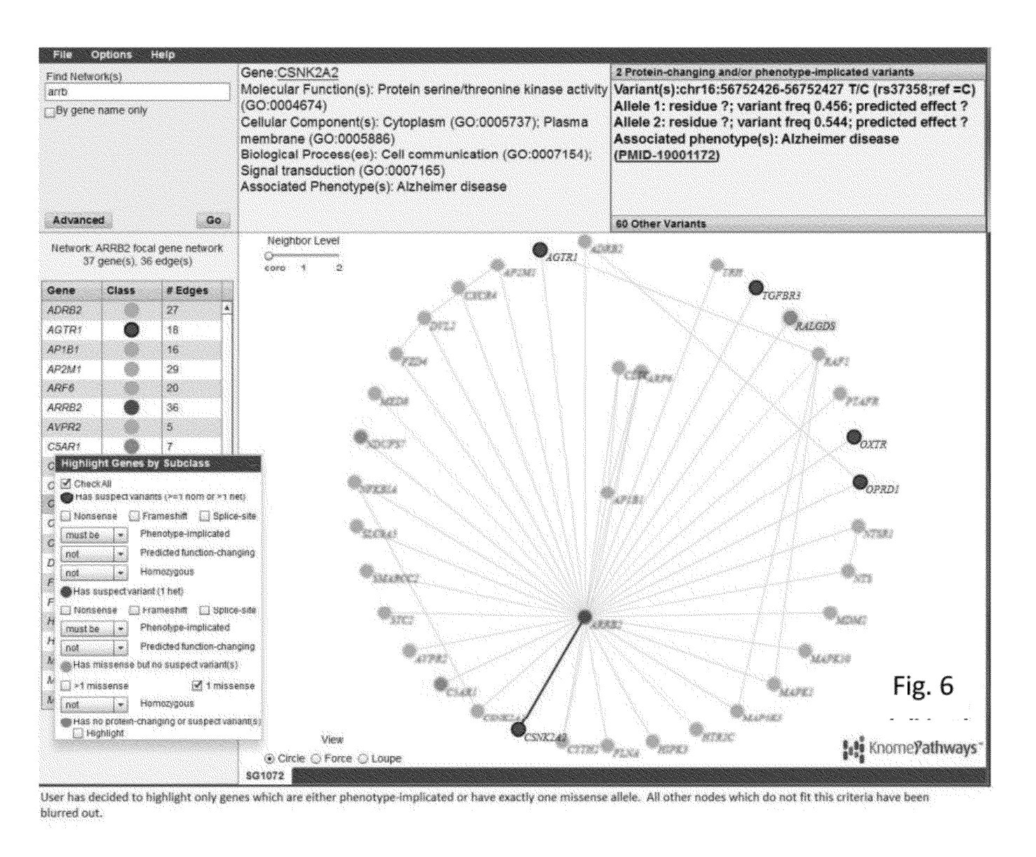

The present invention, in an embodiment, uses a simple node-coloring scheme to let users quickly spot intriguing patterns. To highlight particular genes of a given color, in order to quickly spot those whose color is due to particular kinds of variants, click the ‘Highlight genes by subclass’ button. See FIG. 6. The popup window lets the user to selectively blur genes that do not meet particular variant class criteria. For instance, if you want to highlight (e.g., keep sharp) only genes that carry frameshift variants in the chosen subject genome, check ‘Uncheck All’ and then check ‘Frameshift’ under the first two node classes (red and red-ringed-black). All genes except those carrying at least one frameshift variant will be blurred.

The display can be filtered or modified by the user choosing a desired attribute of the relational network. In this example, FIG. 6, the user application allows the user to modify the display using the color scheme and choose those genes that carry one or more homozygous or multiple heterozygous protein-disrupting (nonsense, read-through, frameshift, or splice) variants (e.g., red circle with black outline), exactly one heterozygous such variant (e.g., red circle), one or more missense (changing one amino acid at one site in the encoded protein to another amino acid)) but no suspect variant (e.g., orange circle), or has no protein-changing or otherwise suspect variant (e.g., gray circle). The display can be filtered or the view can be modified using any criteria, so long as the annotated subject genome and relational networks contain the criteria. For example, the user can chose suspect variants based on the their effect on protein sequence, e.g., a nonsense variant (which cuts short a protein), a frameshift variant (which throws off the reading frame, typically altering many amino acids at many contiguous sites in the protein), or a splice variant (which omits signals that splice together long segments of protein-encoding sequence, typically yielding proteins missing long segments). The user can also sort the data based on phenotypic characteristics (e.g., implication in particular disease or other phenotype), predicted magnitude of effect on protein function, or zygosity (number of copies of the given variant carried among the individual's copies of the chromosome carrying the gene in question). In another embodiment, the user can filter the information based on the number of variants that the gene or overall network contains. In FIG. 6, the display provides only those relational networks associated with ARRB2 in which the individual's genetic variants include at least one gene with a missense variant that is predicted to alter protein function, but no more suspect variant.

In an aspect, the present invention relates to providing a display or output of an individual's genetic information overlaid on a relational network of biological objects, as described herein. An “output device” is defined as a medium for communicating such information or displays, and includes e.g., printouts, monitors showing screen outputs on computers or hand held/mobile devices, email output, and the like. Accordingly, an output device can be any number of devices including a desktop computer, a workstation, a server, a distributed computing system, en embedded system, a stand-alone electronic device, a networked device, a portable computers, a mobile phone, a personal digital assistant (“PDA”), a gaming console, internet kiosk, or other type of a processor or a computer system. Output devices include any device that allows for access to the display of the present invention. Output devices include those that are known in the art and those that are later developed. In another embodiment of the present invention, the display or output of the system can be downloaded to a computer, mobile phone, PDA or other device to view the generated output described herein.

Functionality described herein is described with respect to components for clarity. However, this is not intended to be limiting, as functionality can be implemented on one or more components on one device or distributed across multiple devices.

The present invention relates to a computer system or computer apparatus to carry out the methods described herein e.g., for providing variant genetic sites of an individual overlaid onto one or more relational networks. One environment in which embodiments of the present invention can operate includes a user application configured to communicate with data sources (e.g., databases generated or accessed as described herein) to obtain data. A computer system of the present invention embodies a software program or processor routine to process the data by performing any of the steps described herein including, for example, annotating genetic information, filtering information, providing generated output), and to provide the user with a display or output of an individual's genetic information overlaid on a relational network of biological objects as appropriate. The user application can be implemented in software (e.g., C, C++, Java, or other suitable programming language) that executes on a computer processor. However, other embodiments can be implemented, for example, in hardware (such as in gate level logic or ASIC), or firmware (e.g., microcontroller configured with I/O capability for receiving data from external sources and a number of routines for generating and transferring of a configuration data as described herein), or some combination thereof.

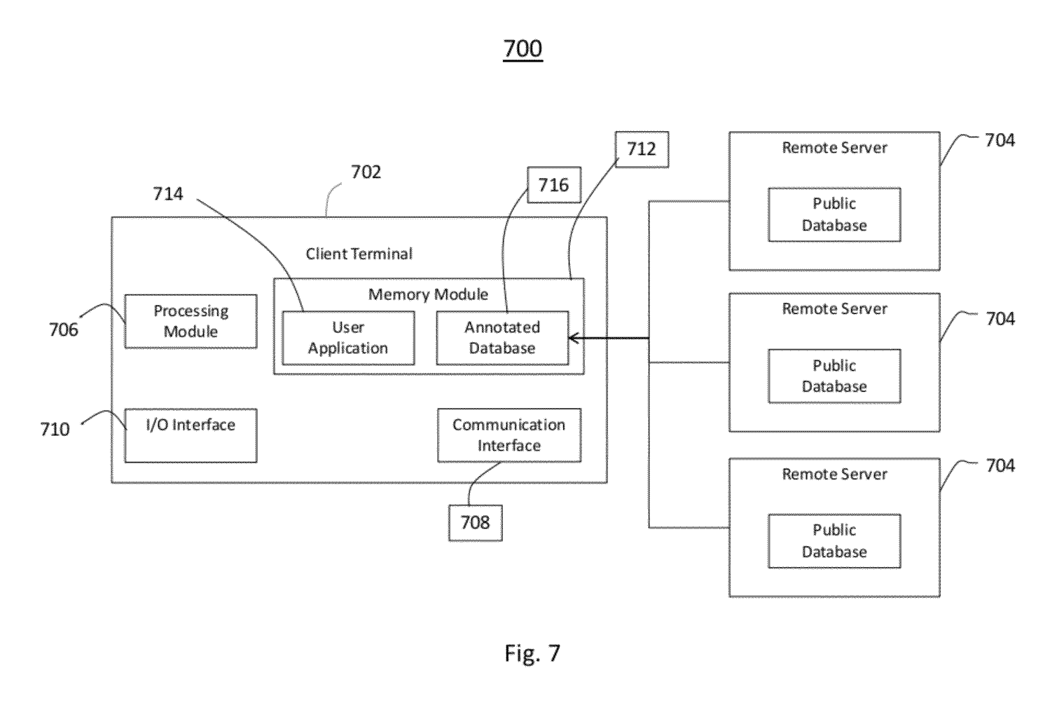

Computer system (e.g., client terminal, remote server) in which a user application can operate can include a processing module, a memory module, a communication interface, and an input/output interface (“IO interface”). As illustrated in FIG. 7, an system 700 includes a client terminal 702 and a remote server 704. The client terminal 702 includes a processing module 706, a communication interface 708, a I/O interface 710, and a memory module 712. Although not illustrated in FIG. 7, the remote server can also include a processing module, a communication interface, a I/O interface, and a memory module, or any combination thereof, to execute the user application 714. As depicted in FIG. 7, the remote server 704 is operatively coupled to various publicly available databases. In some embodiments, information or data to be processed by the processing module 706 are received from other networked components (e.g., other computers, remote servers). In some other embodiments, at least portion of information being stored in the annotated database 716 are obtained from one or more public databases that are operatively coupled to one or more remote servers 704. The connections between the client terminal 702, the remote server 704, and various other networked components, can be provided as computer network links (physical, optical, wireless or otherwise) on a local area network, a wide area network, the internet or other type of network, or a combination thereof. Such connections permit communication through the use of appropriate data communication protocols.

The memory module 712 can be implemented in high speed random access memory and may also include non-volatile memory, such as one or more magnetic or optical storage disks. The memory module 712 may store other programs and/or programs, such as an operating system for handling various basic system services and for performing hardware dependent tasks. The memory module 712 can optionally store other application programs, such as a browser application, for accessing other computers (e.g. remote server 704) as well as databases and applications stored therein via the internet of other computer network links.

Although, in FIG. 7, the user application 714 and the annotated database 716 are illustrated to be contained in a memory module 712 of the single client terminal 702, in some embodiments, the user application 714 and the annotated database 716 can be implemented using multiple discrete memory modules of a system as appropriate. For example, the user application 714 could be implemented in a high speed random access memory module while the annotated database 716 is implemented in a non-volatile memory module. Also, in some other embodiment, the user application 714 and the annotated database 716 can be implemented in a remote server. For instance, the user application 714 can be implemented as a server-side application running on a remote server (e.g., remote server 704), and the user can access the user application 714 from the client terminal 702 via network using additional applications (e.g., web-browser) configured to communicate with the user application 714. In another embodiment, the user application 714 and the annotated database 716 could be implemented on discrete systems. For example, the user application 714 could be implemented on the client terminal 702, and the annotated database 716 could be implemented on a remote server 704.

In operation, the user application 714 filters an individual's genetic data to eliminate certain genetic sites, and determines, depending on the type of analysis, which visualizations of similarity and difference to offer. More specifically, the individual's genetic data is filtered by eliminating non-variable sites (i.e., sites that have shown the same sequence in all individuals studied. The user application then filters out variable sites that are not located in genes, gene-regulating segments, or other contiguous or dispersed genome segments of interest. Such processes of filtering individual's genetic data can be carried out by, for example, the processing module 706. When the filtering process is completed, the processed data of the individual contains information on the individual's variants that is either (a) a genotype at a variable site, or (b) a set of genotypes at different variable sites (as in a “genoset”). This processed data of an individual can be presented to the user via the I/O interface 710, or can be processed further by the processing module 706 as appropriate.

In another embodiment of the present invention, an annotated database 716 is implemented in the system as shown in FIG. 7. The annotated database 716 contains a plurality of annotated datasets that contains information of an individual's genetic variants along with relational networks information about one or more variant-associated biological objects. In an embodiment, the annotated database is populated with a plurality of annotated datasets. Each annotated dataset contains assessment of the exact DNA sequence(s) found at a given position in a given subject genome, as well as other ancillary information. The annotated dataset can include, for example without limitation, the specific DNA bases (e.g., As, Ts, Cs, Gs) at that position. The information on the identified variants of one or more individuals is indexed (annotated) to relational networks and the associated biological objects for the variant. Information on biological objects can be obtained from various publicly databases operatively coupled to one or more remote servers (704) or other informational sources. The annotated database 716 can be structured in the memory module 712 of the client terminal 702. In other embodiment, the annotated database 716 can be implemented in a remote computer system (e.g., remote server) accessible via network. Also, in some embodiments, the annotated database 716 can be implemented using multiple computer systems so as to improve throughput, reliability or other factors. For instance, all three remote servers 704 depicted in FIG. 7 can be used to implement the annotated database 704.

In response to the user's command, the annotated dataset is processed by the processing module 706 to display the relational networks in a manner that conveys distinctive properties of those networks in one or more user-chosen individuals.

Additionally, in some embodiments of the present invention, the user application 716 provides various parameters on the graphical user interface to allow the user to highlight genotypes that meet a combination of additional criteria. In operation, the user provides additional criteria on the user application 716, via I/O interface 708. As mentioned above, the user application 714 can be configured to provide a variety of parameters, which enables the user to further filter or eliminate genotypes at other variant sites from the display. The processing of additional parameters and rendering a filtered view can be carried out by, for example, the processing module 706.

In another embodiment of the present invention, the system 700 allows the user to access the annotated database 716 and retrieve desired information. In operation, the user is provided with a graphical user interface having a field to enter a desired search term. As mentioned above, the user can search for any information stored in the annotated database 716, including gene information, phenotypic information, diseases, conditions, treatments, drugs, and the like. Upon receiving a search term from the user, the user application 714 generates one or more suitable queries to search the annotated database 716 to retrieve information related to the received search term. One or more matching annotated datasets can be processed by, for example, the processing module 706, and/or transferred to I/O interface 710 for display.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1) In a computer system, a method for providing a display of an individual's genomic data overlaid onto one or more relational networks of one or more biological objects on an output device, wherein individual's genomic variant information is annotated with variant information of one or more relational networks having information of one or more biological objects, the method comprises;
providing a display of one or more relational networks having information of one or more biological objects for one or more variants of the individual on the output device.

2) The method of claim 1, wherein the variant information of one or more relational networks having information of one or more biological objects includes information about genes, regulatory regions, promoters or enhancers of the variant, disease, condition, symptoms, protein interactions or other phenotype.

3) The method of claim 1, wherein the display further comprises a representation of the relationship between the relational networks.

4) The method of claim 1, further comprising providing a representation of one or more characteristics of the variant associated with one or more relational networks.

5) The method of claim 4, wherein the characteristics of the variant represented includes one or more heterozygous variants, one or more homozygous variants, a missense variant, a suspect variant, a novel variant, or a non-suspect variant.

6) The method of claim 5, wherein the characteristic of the variant is represented by one or more colors, symbols, shapes, numbers, characters, or a combination thereof.

7) In a computer system, a method for providing a display of one or more individual genomic datasets overlaid onto one or more relational networks of one or more biological objects, to a user, the method comprises;
a) providing a database comprising individual genomic variant information from one or more individuals wherein the individual genomic variant information is annotated with variant information of one or more relational networks having information of one or more biological objects; and
b) providing a display on an output device, wherein the display comprises one or more relational networks having information of one or more biological objects for one or more variants of the individual and a representation of one or more characteristics of the variant associated with one or more relational networks, wherein the display is generated from the information stored in the database, and wherein the biological objects includes information about genes, regulatory regions, promoters or enhancers of the variant, disease, condition, symptoms, protein interactions or other phenotype.

8) The method of claim 7, wherein the characteristics of the variant represented includes one or more heterozygous variants, one or more homozygous variants, a missense variant, a suspect variant, a novel variant, or a non-suspect variant.

9) The method of claim 8, wherein the characteristic of the variant is represented by one or more colors, symbols, shapes, numbers, characters, or a combination thereof

10) The method of claim 9, wherein the information of the biological objects for the relational networks comprises information reported in a journal article or found in a publicly available database of medical information.

11) The method of claim 7, wherein the display includes one or more relational networks having information from more than one individual genome.

12) In a computer system, a method for providing a display of an individual's genomic data overlaid onto one or more relational networks of one or more biological objects, on an output device, the method comprises:
a) providing a database comprising a plurality of annotated datasets, wherein each annotated dataset contains individual genomic variant information annotated with variant information of one or more relational networks having information of one or more biological objects,
b) obtaining the annotated dataset corresponding to the user's search string for a display, wherein the display comprises one or more relational networks in response to a user's search string, wherein the relational networks has information of one or more biological objects for one or more variants of the individual and a representation of one or more characteristics of the variant associated with one or more relational networks; wherein the biological objects includes information about genes, regulatory regions, promoters or enhancers of the variant, disease, condition, symptoms, protein interactions or other phenotype;
c) providing a representation of the relationship between the relational networks; and
d) providing information about the variant.

13) The method of claim 12, wherein information about the variant provided comprises positional information, the nucleic acid residue at the variant position, phenotypic information or a combination thereof.

14) A computer system for providing a display of an individual's genomic data overlaid onto one or more relational networks of one or more biological objects, the apparatus comprises:
a) one or more processing modules;
b) an input/output interface for presenting the display to a user; and
c) memory module for storing one or more programs to be executed by the processing module, wherein the one or more programs has instructions to perform the steps comprising:
i) obtaining a source of individual genomic variant information that is annotated with variant information of one or more relational networks having information of one or more biological objects; and
ii) processing information from the annotated dataset for a display of one or more relational networks having information of one or more biological objects for one or more variants of the individual.

15) The computer system of claim 14, wherein the display comprises variant information of one or more relational networks having information of one or more biological objects that includes information about genes, regulatory regions, promoters or enhancers of the variant, disease, condition, symptoms, protein interactions or other phenotype.

16) The computer system of claim 14, wherein the display further comprises a representation of the relationship between the relational networks.

17) The computer system of claim 14, wherein the display further comprises a representation of one or more characteristics of the variant associated with one or more relational networks.

18) The computer system of claim 17, wherein the display comprises characteristics of the variant represented that includes one or more heterozygous variants, one or more homozygous variants, a missense variant, a suspect variant, a novel variant, or a non-suspect variant.

19) The computer system of claim 18, wherein the characteristic of the variant is represented by one or more colors, symbols, shapes, numbers, characters, or a combination thereof.

20) A computer readable storage medium storing one or more programs to be executed by one or more processing module, wherein the one or more programs has instructions to perform the steps comprising:
i) obtaining a source of individual genomic variant information that is annotated with variant information of one or more relational networks having information of one or more biological objects; and
ii) processing information from the annotated dataset for a display of one or more relational networks having information of one or more biological objects for one or more variants of the individual.

21) The computer readable storage medium of claim 20, further comprising:
a) providing a display of an individual's genomic data overlaid onto one or more relational networks of one or more biological objects.

22) The computer readable storage medium of claim 20, wherein the variant information of one or more relational networks having information of one or more biological objects includes information about genes, regulatory regions, promoters or enhancers of the variant, disease, condition, symptoms, protein interactions or other phenotype.

23) The computer readable storage medium of claim 20, wherein the display further comprises a representation of the relationship between the relational networks.

24) The computer readable storage medium of claim 20, further comprising providing a representation of one or more characteristics of the variant associated with one or more relational networks.

25) The computer readable storage medium of claim 20, wherein the characteristics of the variant represented includes one or more heterozygous variants, one or more homozygous variants, a missense variant, a suspect variant, a novel variant, or a non-suspect variant.

26) The computer readable storage medium of claim 25, wherein the characteristic of the variant is represented by one or more colors, symbols, shapes, numbers, characters, or a combination thereof.

27) The computer readable storage medium of claim 20, further comprising:
a) instructions for generating an annotated dataset, wherein the annotated dataset contains genomic variant information annotated with variant information of one or more relational networks each referencing information of one or more biological objects, and wherein the information of the biological objects for the relational networks comprises information reported in a journal article or found in a publicly available database of medical information.

28) The computer readable storage medium of claim 20, further comprising:
a) receiving a search term from a user;
b) communicating with the annotated database to obtain one or more annotated datasets relating to the search term; and
c) presenting to the user on an output device, one or more relational networks having information of one or more biological objects for one or more variants of the individual in reference to the obtained annotated data
